(19) United States
(12) Patent Application Publication
(10) Pub. No.: US 2020/0207040 A1
(43) Pub. Date: Jul. 2, 2020

(54) SYSTEM AND METHOD FOR REPAIRING A THREE-DIMENSIONAL ARTICLE

(71) Applicant: 3D Systems, Inc., Rock Hill, SC (US)

(72) Inventor: Jeffrey Kenneth Blank, Tigard, OR (US)

(21) Appl. No.: 16/703,204

(22) Filed: Dec. 4, 2019

Related U.S. Application Data
(60) Provisional application No. 62/786,776, filed on Dec. 31, 2018.

(51) Int. Cl. B29C 73/04; B33Y 30/00; B33Y 50/02; B29C 64/393; B29C 64/209

(52) U.S. Cl. CPC B29C 73/04; B33Y 30/00; B29C 64/209; B29C 64/393; B33Y 50/02

(57) ABSTRACT

A manufacturing method is for repairing a damaged three-dimensional (3D) article having a fracture zone which is a site of a broken-off portion of the 3D article. The method includes using a forming tool to form an attachment feature into material at the fracture zone, imaging the 3D article including the fracture zone to provide image data, defining a repair portion 3D body based upon a comparison between the image data and data defining an intact 3D body, printing the repair portion 3D body including a complementary attachment features, and attaching the repair portion to the damaged 3D article through the interengagement of the complementary attachment feature and the attachment feature.

### CROSS-REFERENCE TO RELATED APPLICATIONS

This non-provisional patent application claims priority to U.S. Provisional Application Ser. No. 62/786,776, Entitled “SYSTEM AND METHOD FOR REPAIRING A THREE-DIMENSIONAL ARTICLE” by Jefferey Kenneth Blank, filed on Dec. 31, 2018, incorporated herein by reference under the benefit of U.S.C. 119(e).

### FIELD OF THE INVENTION

The present disclosure relates to three-dimensional (3D) printing. More particularly, the present disclosure relates to restoration of a broken three-dimensional (3D) article.

### BACKGROUND

Three-dimensional (3D) printing is an effective way to manufacture customized or low volumes of complex articles. Generally, the cost per unit article of 3D printing is much higher than that of higher volume processes such as injection molding. Some of the complex articles that are fabricated suffer from breakage either during fabrication or handling.

### BRIEF DESCRIPTION OF THE FIGURES

FIG. 1 is a schematic block diagram of an embodiment of a 3D print engine electrically or wirelessly coupled to a controller.

FIG. 2 is a schematic diagram depicting an embodiment of a repair kit for restoring a broken 3D article.

FIG. 3 is a flowchart of an embodiment of a manufacturing method for repairing a damaged 3D article.

FIG. 4A is a side view diagram depicting a damaged 3D article with a fracture zone at which a portion of the 3D article has broken off.

FIG. 4B is a diagram depicting a fracture zone. An attachment feature or recess has been formed into the material at the fracture zone.

FIG. 4C is a cross-sectional diagram depicting a damaged 3D article with an attachment feature formed into material underlying the fracture zone.

FIG. 4D is a side view diagram depicting an intact 3D article.

FIG. 4E is a side view diagram depicting a repair portion.

FIG. 4F is a side view diagram depicting a restored or repaired 3D article.

FIG. 5 is a flowchart of a method performed by a controller as part of a process for restoring a damaged 3D article.

FIG. 6 is a schematic diagram depicting an embodiment of a forming tool used to form an attachment feature into material at a fracture zone of a damaged 3D article.

FIG. 7A is a diagram depicting a first embodiment of a tip of a forming tool.

FIG. 7B is a diagram depicting a second embodiment of a tip of a forming tool.

FIG. 7C is a diagram depicting a third embodiment of a tip of a forming tool.

### SUMMARY

In a first aspect of the disclosure, a manufacturing method is for repairing a damaged three-dimensional (3D) article having a fracture zone which is a site of a broken-off portion of the 3D article. The method includes using a forming tool to form an attachment feature into material at the fracture zone, imaging the 3D article including the fracture zone to provide image data, defining a repair portion 3D body based upon a comparison between the image data and data defining an intact 3D body, printing the repair portion 3D body including a complementary attachment feature, and attaching the repair portion to the damaged 3D article through the interengagement of the complementary attachment feature and the attachment feature.

In one implementation the damaged 3D article includes a thermoplastically deformable material at the fracture zone. Forming the attachment feature includes pressing a heated tip of the forming tool into the deformable material at the fracture zone to form one or more recesses extending into the material of the fracture zone. The thermoplastically deformable material can include a wax material.

In another implementation the attachment feature and the complementary attachment feature have a complementary keying geometry. The complementary keying geometry assures that interengagement between the attachment feature and the complementary attachment feature constrains a location and orientation of the repair portion 3D body with respect to the damaged 3D article.

Yet another implementation includes storing data defining a plurality of different complementary attachment features. Defining the repair portion 3D body includes selecting one of the plurality of different complementary attachment features based upon the image data from the fracture zone.

In a further implementation defining the repair portion 3D body includes defining a 3D body of the damaged 3D article based upon the image data and Boolean subtracting the 3D body of the damaged 3D article from the intact 3D body to define an initial repair portion 3D body. Defining the repair portion 3D body can also include forming a Boolean union between the initial repair portion 3D body and the complementary attachment portion to define the repair portion 3D body.

In a yet further implementation the engagement feature is a recess formed into the material of the fracture zone. The complementary engagement feature is an upstanding feature that extends outwardly from a complementary surface of the repair 3D body. The complementary surface generally matches the fracture zone. Interengagement of the engagement feature and the complementary engagement surface occurs when the upstanding feature is received into the recess. An interference fit between the upstanding member and the recess provides resistance to removing the repair portion 3D body from the damaged 3D article.

In a second aspect of the disclosure, a kit is for repairing a damaged 3D article having a fracture zone at which a portion of an intact 3D article was broken off. The kit at least includes a forming tool, an imaging device, and a non-transient media. The forming tool is for forming an attachment feature into material at the fracture zone. The imaging device is for capturing an image of the damaged 3D article including the fracture zone. The non-transient media stores software instructions. When executed by a processor the software instructions perform the following steps: (1) perform a comparison between the image of the damaged 3D article and an intact 3D body defining the intact 3D article and (2) define a repair portion 3D body based on the comparison and including a complementary attachment feature for engaging the attachment feature when the repair portion is assembled to the damaged 3D article.

In one implementation the forming tool includes an integral heating unit attached to a heated tip. The heated tip defines a geometry of the attachment feature when it is pressed in to the fracture zone.

In another implementation the kit includes a separate heating source for heating a tip of the forming tool. The heated tip defines a geometry of the attachment feature when it is pressed in to the fracture zone.

In yet another implementation the forming tool includes a handle and a plurality of interchangeable tips. One of the plurality of interchangeable tips can be selected and attached to the handle based upon a desired geometry of an attachment feature.

In a further implementation the forming tool includes a plurality of different forming tools and/or tips for forming different attachment feature geometries into material at the fracture zone. Defining the repair portion can include selecting a complementary attachment feature based on which of the different forming tools and/or tips is used for forming the attachment feature.

In a yet further implementation the attachment feature and complementary attachment feature have a complementary keying geometry. The complementary keying geometry assures that interengagement between the attachment feature and the complementary attachment feature constrain a location and orientation of the repair portion 3D body when it is attached to the damaged 3D article.

In another implementation defining a 3D body of the damaged 3D article based upon the image of the damaged 3D article and Boolean subtracting the 3D solid body of the damaged 3D article from the intact 3D body to define an initial repair portion 3D body. Defining the repair portion 3D body can also include forming a Boolean union between the initial repair portion 3D body and the complementary attachment portion to define the repair portion 3D body.

In a third aspect of the disclosure, a system is for repairing a damaged 3D article having a fracture zone at which a portion of an intact 3D article was broken off. The system includes a forming tool, an imaging device, a 3D print engine, and a controller. The forming tool is for forming an attachment feature into material at the fracture zone. The imaging device is for capturing an image of the damaged 3D article including the fracture zone with the attachment feature. The controller is configured to define a 3D solid body of the damaged 3D article based upon the image data and define a 3D body of a repair portion based at least partly on a difference between a 3D body of an intact 3D article and the 3D body of the damaged 3D article. The repair portion includes a complementary attachment portion. Defining the 3D body of the repair portion can also include determining the complementary attachment portion geometry based upon the image of the fracture zone with the attachment feature. The controller can be further configured to operate the 3D print engine to print the repair portion.

### DETAILED DESCRIPTION OF THE PREFERRED EMBODIMENTS

FIG. 1 is a schematic block diagram of an embodiment of a 3D print engine 2 electrically or wirelessly coupled to a controller 4. In describing print engine 2, mutually orthogonal axes X, Y, and Z can be used. Axes X and Y are referred to as lateral axes and are generally horizontal. Axis Z is referred to as a vertical axis and is generally aligned with a gravitational reference. “Generally” in regards to alignment refers to an alignment that may not be exact but is by design and within normal manufacturing tolerances.

Print engine 2 includes a build plate 6 for supporting a three-dimensional (3D) article 8. Build plate 6 is supported by an elevator mechanism 10 for at least adjusting a height of the build plate 6. Print engine 2 includes a printhead 12 for depositing drops of an ink for forming 3D article 8 in a layer-by-layer manner. A movement mechanism 14 is configured to impart relative lateral motion along one or two axes between the printhead 12 and the build plate 6. An ink supply 16 is configured to supply ink to the printhead 12.

Controller 4 is controllably coupled to the elevator mechanism 10, the printhead 12, the movement mechanism 14, the ink supply 16, other parts of the print engine 2 and other devices such as a scanner or imaging device. The controller 4 includes a processor coupled to an information storage device. The information storage device includes a non-transient media storing software instructions. When executed by the processor, the software instructions control portions of the print engine and other devices. The controller can be a single integrated computer or it can be distributed among multiple devices. The controller can include a local controller associated with the print engine, a host computer, and/or other devices such as remote server computers.

The controller 4 is configured to perform various tasks such as printing a 3D article 8. The method for printing a 3D article is as follows: (1) The elevator mechanism 10 positions an upper surface 18 of the build plate or an upper surface of the 3D article 8 at a “build plane.” (2) The movement mechanism 14 imparts lateral motion between the printhead 12 and the upper surface as the printhead 12 selectively prints a layer of material onto the 3D article. (3) Steps (1) and (2) are repeated until the 3D article 8 is fabricated.

In an illustrative embodiment, the ink contained within the ink supply 16 is a “phase change” ink that is a solid at room temperature but liquifies at an elevated temperature. The ink is heated to liquid form as it is transported to and printed by the printhead 12. The printhead 12 prints by ejecting a dot matrix pattern of liquid drops upon the upper surface 18. Upon impact with upper surface 18, the liquid drops quickly harden. In one embodiment, the ink can include a wax component that provides the phase change property. Such wax comprising inks are useful for making patterns for investment casting. Such wax comprising inks include but are not limited to the materials disclosed in U.S. Pat. Nos. 6,841,589; 8,575,258; and 9,394,441, which are incorporated by reference herein in their entirety. In some embodiments, the ink can also include a UV curable component to provide increased strength of the 3D article 8 after a radiation curing process. In some embodiments, the ink can include a plurality of different inks having different colors and/or different compositions.

More generally, the ink is a thermoplastically deformable ink. Thus, to an extent, the ink can be shaped and formed with heat and pressure after the 3D article is printed.

The controller 4 stores “original data” defining an intact 3D body which is an intact or unbroken version of a 3D article 8. During a print process, or during subsequent handling, the 3D article 8 may be damaged. This is particularly a risk using wax-based inks and forming intricate and delicate 3D articles 8. A damaged 3D article may be missing a broken off portion. A fracture zone would be a site of the break.

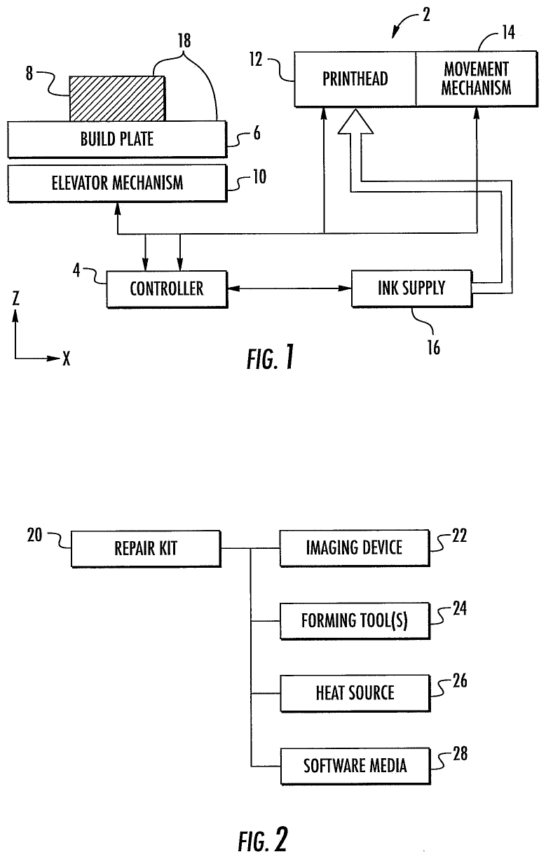

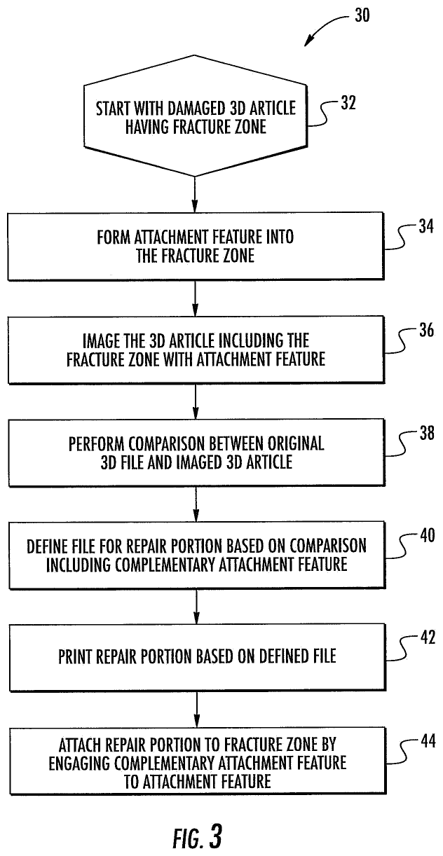

FIG. 2 is a diagram depicting a repair kit 20 for restoring a broken 3D article. In an illustrative embodiment, the repair kit 20 includes an imaging device 22, one or more forming tools 24, an optional heat source 26, and software media 28. The imaging device 22 can be a hand-held scanner for capturing images and image data from a damaged 3D article and providing the data to controller 4. The forming tool 24 is configured to form material at the fracture zone to define an attachment feature. There may be more than one forming tool 24 for different fracture zone geometries. In some embodiments, a forming tool 24 can have interchangeable tips having varying tip geometries. The heat source 26 is for heating a tip of the forming tool 24 before use. The heat source 26 can be an electrically heated plate. Alternatively, the forming tool 24 may incorporate an integral heat source 26. The software media 28 stores software instructions to be executed by a processor in controller 4 (or a counterpart of controller 4) to facilitate the repair. Embodiments of the software execution will be described with respect to FIGS. 3 and 5. The software media 28 can a hand-held media such as a flash drive or a compact disc. Alternatively, the software media may be remotely stored in a server but accessible by controller 4.

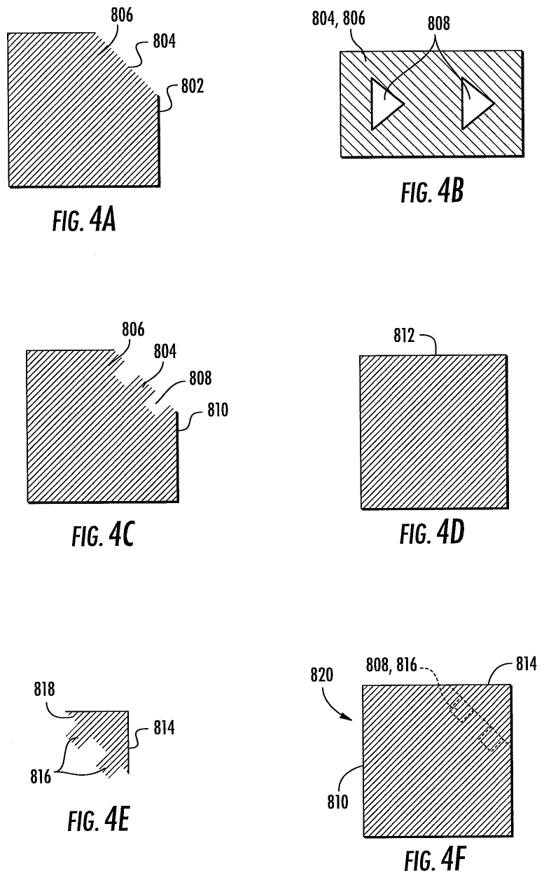

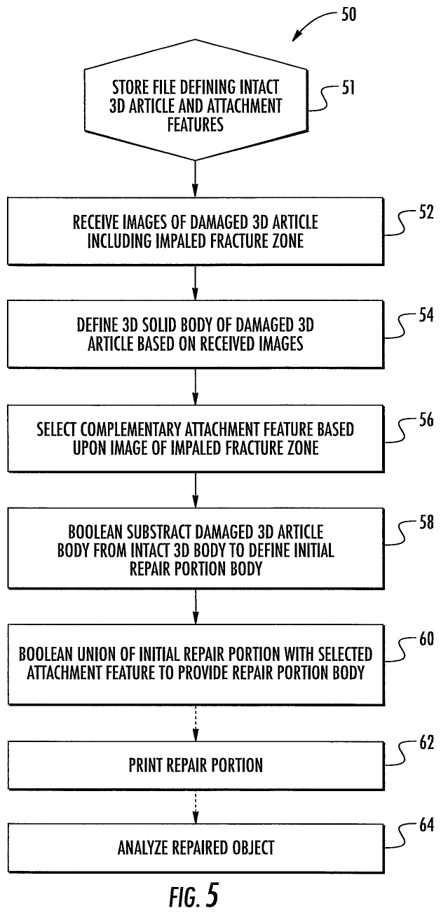

FIG. 3 is a flowchart of an embodiment of a manufacturing method 30 for repairing a damaged 3D article 8. FIGS. 4A-F are illustrations that correspond to steps of FIG. 3 and illustrate variations or portions of 3D articles 8 involved with the repair process. Therefore, these will be labeled 8MN, in which the first digit 8 corresponds to a printed 3D article 8 and the last two digits MN correspond to which portion is involved.

According to 32, a 3D article 8 has been damaged. Thus, method 30 starts with a damaged 3D article 802 having a fracture zone 804. The fracture zone 804 is a broken surface at which a portion of the damaged 3D article 802 has broken off. The fracture or break may have happened during manufacture, handling, or use of the now-broken 3D article 802. Underlying the fracture zone 804 is material 806 in the vicinity of the fracture zone 804.

According to 34, the forming tool 24 is utilized to form an attachment feature 808 into the material 806 of the fracture zone 804. In the illustrated embodiment of FIGS. 4B and 4C, the attachment feature 808 includes two recesses 808. The recesses 808 have an asymmetric geometry which provides an important function to be described infra. In the illustrative embodiment, the forming tool 24 has a heated tip that is pressed into the material 806 to form the recesses 808. Thus, the recesses 808 are formed with heat and pressure applied by the heated tip. FIG. 4C illustrates the 3D article 810 with the attachment feature (recesses) 808 formed into the material 806 of the fracture zone 804.

According to 36, the imaging device 22 is utilized to image or scan the damaged 3D article. This includes capturing an image of the fracture zone 804 and the attachment feature(s) or recess(es) 808.

FIG. 4D depicts an intact article or body 812 defined by an initial or original data file for article 812. The imaged or scanned data of the damaged 3D article 810 defines a damaged 3D body 810. According to 38, comparison is made between the intact 3D body 812 and the damaged 3D body 810.

According to 40, a file or 3D body for a repair portion 814 is defined based at least upon the comparison of step 38. Also defined is a complementary attachment feature 816. In the illustrative embodiment, the repair portion includes a complementary surface 818 intended to generally match the fracture zone 804. Complementary attachment features 816 are referred to as complementary because they are upstanding features 816 having a geometry to be received into the recesses 808.

According to 42, the print engine 2 is operated to print the repair portion 814. According to 44, the repair portion 814 is attached to the damaged 3D article 810 to provide a repaired or restored 3D article 820. In the illustrative embodiment of FIG. 4B, the attachment features 808 have a “keying” function. This is provided by an asymmetry whereby an orientation and alignment of the repair portion 814 with respect to the damaged portion 810 is constrained by the interengagement of the attachment features 808 and the complementary attachment features 816. As a result, a difficulty of properly aligning the repair portion 814 to the damaged article 810 is reduced. The interengagement of the attachment features 808 and the complementary attachment features 816 also secures the repair portion 814 to the damaged article 810. Preferably the fit between an upstanding feature 816 and a recess 808 is an interference fit which will frictionally resist removal of the repair portion 814 from the damaged article 810 once attached. In some embodiments, adhesives or waxes can be used to bond the upstanding feature 816 to the recess 808.

FIG. 5 is a flowchart of a method 50 performed by the controller 4. Steps 52-60 correspond to steps 36-40 of method 30, but steps 52-60 are a more particular embodiment of these steps. Step 62 corresponds to step 42.

According to 51, controller 4 stores a file defining an intact 3D body 812. The controller 4 also stores a plurality of files defining a selection of different complementary attachment features 816 corresponding individually to the heated tip geometries a plurality of forming tools 24 (or interchangeable tips).

According to 52, the controller 4 receives images captured from the damaged 3D article 810. The images include images of the fracture zone 804 with the attachment feature 808 formed therein.

According to 54, the controller 4 defines a damaged 3D body 802 based upon the received images. According to 56, the controller selects a file defining a complementary attachment feature 816 from the stored plurality of files based upon an image of the fracture zone 804 and the formed attachment feature 808. As a note, steps 54 and 56 can be concurrent or be performed in a reverse order.

According to 58, the controller 4 performs a Boolean subtraction of the damaged 3D body 802 from the intact 3D body 812 (812 NOT 802) to define an initial repair portion 3D body. According to 60 the controller 4 performs a Boolean addition (union) of the initial repair portion 3D body and the selected complementary attachment feature body 816 to provide the repair portion 3D body 814.

According to 62, the controller 4 operates the print engine 2 to print the repair portion 814. After the repair portion 814 is printed, it can be coupled to the damaged 3D article 810 to result in the restored 3D article 820.

The restored 3D article can be scanned or imaged by the imaging device 22. Then, according to 64, the controller 4 can analyze the restored 3D article 820. This can include a comparison of the restored body 820 with the initial intact body 812. Such a comparison may include a Boolean subtraction between 812 and 820. As part of 64, the controller may provide an indication to a user as to the accuracy of the restored 3D article 820 relative to the intact 3D body 812.

FIG. 6 is a schematic diagram depicting an embodiment of a forming tool 24 used to form the attachment feature or recess 808 into the material 806 of fracture zone 804. The forming tool can include a thermally insulated handle 66, a heating unit 68, and a heated tip 70. In use, a user grips the insulated handle 66 and presses the heated tip 70 into the material 806 of fracture zone 804 to form the recess 808. In one embodiment, the heated tip 70 is interchangeable. Along with forming tools 24, the kit 20 can include a plurality of interchangeable tips each corresponding to a different geometry of a desired attachment feature 808.

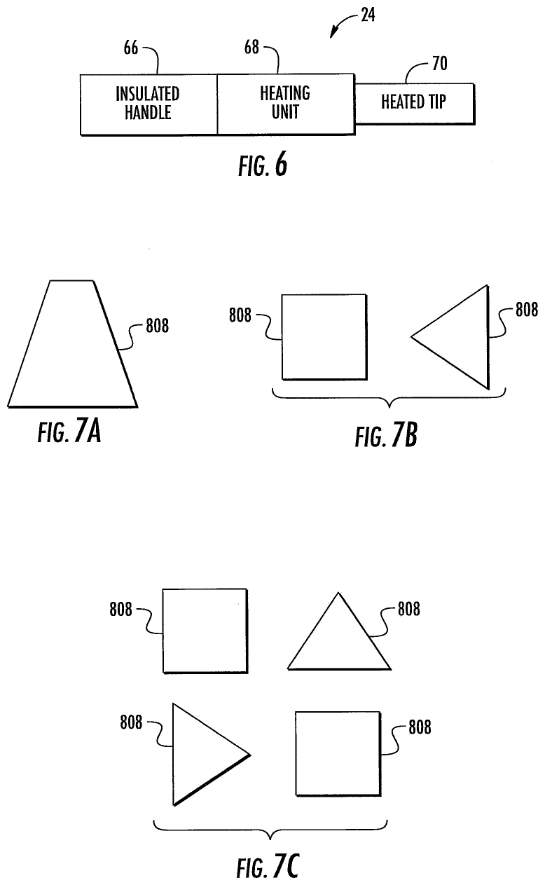

Generally speaking, a desired attachment feature 808 geometry can be a function of the geometry of the fracture zone 804. For a very small fracture zone 804, it may be desirable for the tip 70 to form a single recess 808, as illustrated in FIG. 7A. For a relatively narrow but elongate fracture zone, it may be desirable to form a pair or generally linear array of recesses 808 as illustrated in FIG. 7B. For a larger area, it may be desirable to form a two dimensional array of recesses as illustrated in FIG. 7C. For all of these embodiments, it is preferable that they provide a complementary keying geometry—that is, the interengagement geometry between the upstanding features 816 and the recesses 808 constrain the location and orientation of the repair portion 814 with respect to the damaged 3D article 810. This assures that the restored 3D article 820 will match the intact 3D body 812 as accurately as possible without a requirement of extreme user skill and dexterity.

The specific embodiments and applications thereof described above are for illustrative purposes only and do not preclude modifications and variations encompassed by the scope of the following claims.

What is claimed:

1. A manufacturing method of repairing a damaged 3D article having a fracture zone which is a site of a broken-off portion of the 3D article comprising:
using a forming tool to form an attachment feature into material at the fracture zone;
imaging the 3D article including the fracture zone to provide image data;
defining a repair portion 3D body based upon a comparison between the image data and data defining an intact 3D body;
printing the repair portion 3D body including a complementary attachment feature; and
attaching the repair portion to the damaged 3D article through the interengagement of the complementary attachment feature and the attachment feature.

2. The method of claim 1 wherein the damaged 3D article includes a thermoplastically deformable material at the fracture zone, forming the attachment feature includes pressing a heated tip of the forming tool into the deformable material at the fracture zone to form one or more recesses extending into the material of the fracture zone.

3. The method of claim 2 wherein the thermoplastically deformable material includes a wax material.

4. The method of claim 1 wherein the attachment feature and complementary attachment feature have a complementary keying geometry that constrains a location and orientation of the repair portion with respect to the damaged 3D article.

5. The method of claim 1 further comprising storing data defining a plurality of different complementary attachment features and wherein defining includes selecting one of the plurality of different complementary attachment features based upon the image data from the fracture zone.

6. The method of claim 1 wherein defining the repair portion 3D body further comprises:
defining a 3D body of the damaged 3D article based upon the image data; and
Boolean subtracting the 3D body of the damaged 3D article from the intact 3D body to define an initial repair portion 3D body.

7. The method of claim 6 further comprising forming a Boolean union between the initial repair portion 3D body and the complementary attachment portion to define the repair portion 3D body.

8. A kit for repairing a damaged 3D article having a fracture zone at which a portion of an intact 3D article was broken off comprising:
a forming tool for forming an attachment feature into material at the fracture zone;
an imaging device for capturing an image of the damaged 3D article including the fracture zone;
a non-transient media storing software instructions which, when executed by a processor, perform the following steps:
perform a comparison between the image of the damaged 3D article and an intact 3D body defining the intact 3D article; and
define a repair portion 3D body based on the comparison and including a complementary attachment feature for engaging the attachment feature when the repair portion is assembled to the damaged 3D article.

9. The kit of claim 8 wherein the forming tool includes an integral heating unit attached to a heated tip, the heated tip defines a geometry of the attachment feature when it is pressed into the fracture zone.

10. The kit of claim 8 further comprising a separate heat source for warming a tip of the forming tool.

11. The kit of claim 8 wherein the attachment feature and complementary attachment feature have a complementary keying geometry that constrains a location and orientation of the repair portion when it is assembled to the damaged 3D article.

12. The kit of claim 8 wherein the forming tool includes a plurality of different forming tool tips and/or complete forming tools to allow a selection from a plurality of different attachment feature geometries to be formed into the material at the fracture zone.

13. The kit of claim 12, wherein defining the repair portion 3D body includes selecting a complementary attachment feature from a plurality of different complementary attachment feature geometries based upon the selected attachment feature geometry.

14. The kit of claim 8 wherein defining the repair portion 3D body includes:
defining a 3D body of the damaged 3D article based upon the image of the damaged 3D article; and
Boolean subtracting the 3D solid body of the damaged 3D article from the intact 3D body to define an initial repair portion 3D body.

15. The kit of claim 8 wherein defining a repair portion 3D body further includes forming a Boolean union between the initial repair portion 3D body and the complementary attachment portion.

16. A system for repairing a damaged 3D article having a fracture zone at which a portion of an intact 3D article was broken off comprising:
a forming tool for forming an attachment feature into material at the fracture zone;
an imaging device for capturing an image of the damaged 3D article including the fracture zone with the attachment feature;
a 3D print engine; and
a controller including a processor coupled to a non-transient media storing software instructions, execution of the software instructions by the processor cause the controller to:
define a 3D solid body of the damaged 3D article based upon the image data; and
define a 3D body of a repair portion based at least partly on a difference between a 3D body of an intact 3D article and the 3D body of the damaged 3D article, the repair portion including a complementary attachment portion.

17. The system of claim 16 wherein defining the 3D body of the repair portion also includes determining the complementary attachment portion geometry based upon the image of the fracture zone with the attachment feature.

18. The system of claim 16 wherein defining a 3D body of the damaged 3D article based upon the image of the damaged 3D article; and
Boolean subtracting the 3D solid body of the damaged 3D article from the intact 3D body to define an initial repair portion 3D body.

19. The system of claim 16 wherein defining a repair portion 3D body further includes forming a Boolean union between the initial repair portion 3D body and the complementary attachment portion.

20. The system of claim 16 wherein the controller operates the 3D print engine to print the repair portion.
